(19) United States
(12) Patent Application Publication
(10) Pub. No.: US 2009/0183836 A1
(43) Pub. Date: Jul. 23, 2009

(54) Apparatus for Glueing Together the Wrap of An Endless Tow of Filter Material

(75) Inventor: Michael Riedel, Geldern (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: International Tobacco Machinery B.V., AH Eindhoven (NL)

(21) Appl. No.: 12/299,181

(22) PCT Filed: Apr. 28, 2007
(86) PCT No.: PCT/EP2007/003785

§ 371 Date: Oct. 31, 2008

(30) Foreign Application Priority Data
May 24, 2006 (DE) 10 2006 025 056.7

(51) Int. Cl. B27G 11/02

(52) U.S. Cl. 156/379.6

(57) ABSTRACT

An apparatus for glueing together the wrap of an endless tow of filter material in the manufacture of cigarette filters, with an application station for hot melt adhesive, in which hot melt adhesive is applied to the flat endless web of the wrap, a wrapping station, in which the endless web is laid around the endless tow of filter material, a pre-heating station, in which the hot melt adhesive on the endless web is pre-heated to a preset temperature, while the wrap is brought into immediate contact with a heating surface in the region where adhesive is applied, and with a cooling station, in which the hot melt adhesive is cured, wherein a cooling apparatus is assigned to the pre-heating station, which causes a cooling of the heating surface when the temperature on the heating surface exceeds a preset value.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to an apparatus for glueing together the wrap of an endless tow of filter material.

In the manufacture of cigarette filters, an endless filter tow is produced at first. For this purpose, the filter material (tow acetate) is taken out of a storage vessel and it is processed. In this state, it is guided to an inlet finger in a subsequently arranged tow-forming unit via a transportation nozzle. The acetate tow is brought into a round shape by doing so. An endless-running strip of a flat material, paper in particular, serves as a wrap and is laid around the acetate tow.

Glueing together the paper is usually performed with a hot melt adhesive, which is applied as a thin strip in the running direction of the paper web with the aid of a particular heatable nozzle. In the region of the inlet finger, the paper strip is slowly brought into its round shape and it begins to wrap the filter material. In this, the lateral edges of the paper strip overlap each other. The glueing together takes place by curing the hot melt adhesive under a cooling bridge, the so-called upper format. In this, the paper with the glue strip overlapping itself is pressed onto each other, and then it is cured by a continuously cooled format rail in a path as short as possible.

For glueing together as uniformly as possible and for achieving a diameter as constant as possible without fluctuations, it is important that the hot melt adhesive is in a constant state of aggregation immediately before the glueing. This is provided by a pre-heating device, which is situated immediately before the cooling bridge and by which the glue seam is heated to a certain temperature which is optimal for glueing. The heat transfer takes usually place by immediate contact between the paper and a heating surface.

At the same time, the tow formation by wrapping the paper web around the filter material takes place in the pre-heating apparatus. By pressing together the filter material and by the relative speed of the filter material with respect to the heating surface, friction is generated which can have the result that a pre-heating far above the required temperature takes place, through which the glue becomes liquid to such an extent that glueing together is no more possible. In this case, the manufacture is interrupted. Too high a friction can arise in that the inner pressure of the tow acetate takes on a very high value in the tow formation, because a special sort of acetate has been used or because the user produces relatively heavy filter bars. However, the mentioned difficulty may even occur with usual filter weights and material specifications, namely then, when a certain manufacturing speed is exceeded and too great amounts of frictional heat are generated through this.

The present invention is based on the objective to provide an apparatus for glueing together the wrap of an endless tow of filter material in the manufacture of cigarette filters, in which a uniform glueing together without fluctuations of the diameter is achieved.

### BRIEF SUMMARY OF THE INVENTION

In the apparatus according to the present invention, a cooling apparatus is assigned to the pre-heating station, which causes a cooling of the heating surface when the temperature on the heating surface exceeds a preset value.

The invention starts from the finding that for warming up the hot melt adhesive, a certain heating is necessary. Taking into account the tow velocity, the heating can be adjusted such that a certain temperature is obtained on the heating surface. However, when an increase of the temperature takes place due to the described processes, by too great a frictional heat for instance, the cooling apparatus intervenes and cools down the warmed-up heating surface so far that too high warm up of the hot melt adhesive is avoided.

Preferably, at least one temperature sensor is assigned to the heating surface, whose measured temperature value is given up to a control device, wherein the control device adjusts the supply of a coolant depending on the deviation of the measured temperature from a desired temperature value. Preferably, two or more temperature sensors are used, whose values can be averaged. It is per se known to provide a bar shaped block in the pre-heating station, with a flute in which the endless tow is guided and to which a heating apparatus is associated. The cooling device is preferably associated to this bar shaped block. Cooling may take place for instance by exposing the bar shaped block to a flow of a cooling fluid. For instance, this may take place by a flow of air or water which is directed against the block. Another embodiment of the present invention provides for this purpose that at least one cooling channel is formed in the bar shaped block, which extends in the longitudinal direction of the bar shaped block and is connected to the flute in distances via bores, wherein the cooling channel is connected with a source for pressurised cooling fluid. In this way, the pre-heated region of the hot melt adhesive can be contacted with more or less cool, compressed air when a preset temperature value is exceeded. Through this, it is possible to set one constant temperature, which is ideal for glueing together, even across different speed ranges, from the start up to the different manufacturing speeds. In addition, a trouble-free operation of the production machine is secured by the present invention.

### BRIEF DESCRIPTION OF THE SEVERAL VIEWS OF THE DRAWINGS

An example of the realisation of the present invention is explained in more detail in the following by means of drawings.

FIG. 1 schematically shows an apparatus for the manufacture of a cigarette filter tow, the apparatus being one according to the present invention.

FIG. 2 shows a bar shaped block for an apparatus of the present invention in a side view.

FIG. 3 shows the bottom view of the block according to FIG. 2.

FIG. 4 shows the top view on the perspective representation of the block according to FIG. 2.

FIG. 5 shows the bottom side of the block according to FIG. 4 in a perspective view.

FIG. 6 shows a cross section along the line 6-6 through the representation according to FIG. 2.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

Filter tow acetate is supplied corresponding to arrow 10 to a transportation nozzle 12, from which the tow rope is guided to an inlet finger 14. An endless paper web 15 is coated with a strip of hot melt adhesive with the aid of a heatable nozzle 16. In the region of the inlet finger 14, the paper web is slowly brought into a round form and it begins to wrap the filter material to form an endless filter tow which leaves the shown machine at 18. In the action of wrapping the paper web 15 around the tow rope, the paper edges overlap each other, through which a glueing together in the region of a cooling device 20 takes place, in which the hot melt adhesive is cured. Here, the overlapping paper with the glue strip is pressed and the hot melt adhesive is cured in an always cooled format rail. The cooling takes place by cold water, which is supplied via a tube 22 and which is drained via a tube 24.

Before the cooling device 20, the so-called-upper format, a pre-heating station 26 is arranged.

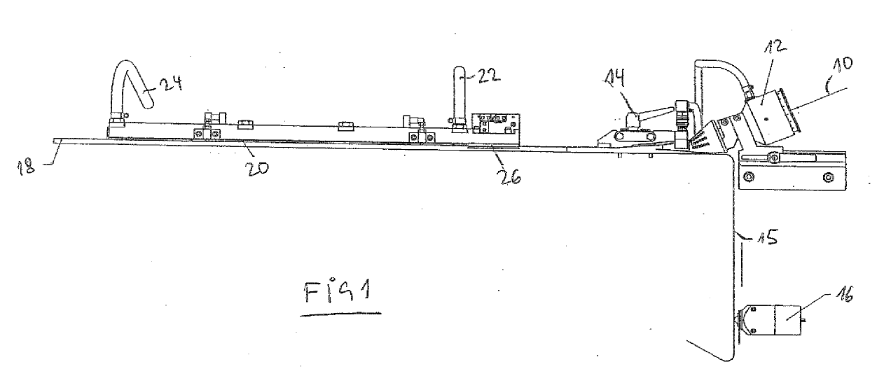

The components of such a machine for producing an endless filter tow represented in FIG. 1 are per se known. However, the pre-heating station contains also parts which differ from the state of the art. To this will be incurred in the following.

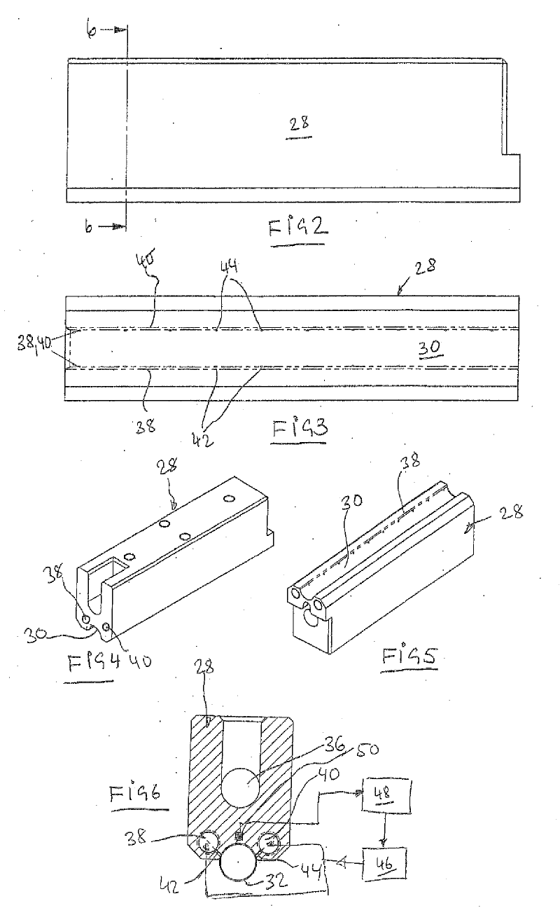

The pre-heating station 26 contains a bar shaped block 28, which is represented in more detail in the FIGS. 2 to 6. On its lower side, it has the flute 30. As can be recognised in FIG. 6, the tow of filter acetate and paper wrap is guided in the flute. This is indicated at 32. The metal made bar shaped block 28 contains an axial bore 36 for receiving a heating cartridge, through the aid of which the surface of the flute 30 is brought to a predetermined temperature. The heated heating surface of the flute 30, whose contour is matched to the circle contour of the filter tow, warms up the hot melt adhesive to the required temperature, so that glueing together can take place, with subsequent curing in the cooling device 20.

Two cooling channels 38, 40 are formed parallel to the bore 36 in the bar shaped block 28, near to the flute 30. The cooling channels 38, 40 are in communication with the flute 30 or its heating surface, respectively, via transverse bores 42 or 44, respectively. The distances can be recognised in the representation of FIG. 3.

The cooling channels 38, 40 are connected to a source 46 for pressurised cool air, which is adjusted by a controller 48. The controller 48 is connected to a temperature sensor 50 near to the flute 30. The controller 48 compares the measured temperature values with a stored preset desired value and it drives the source 46 such that depending on the deviation, more or less cool air is guided through the cooling channels 38, 40, which cool down the temperature of the heating surface of the flute 30.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. An apparatus for glueing together the wrap of an endless tow of filter material in the manufacture of cigarette filters, with an application station for hot melt adhesive, in which hot melt adhesive is applied to the flat endless web of the wrap, a wrapping station, in which the endless web is laid around the endless tow of filter material, a pre-heating station, in which the hot melt adhesive on the endless web is pre-heated to a preset temperature, while the wrap is brought into immediate contact with a heating surface in the region where adhesive is applied, and with a cooling station, in which the hot melt adhesive is cured, characterised in that a cooling apparatus is assigned to the pre-heating station (26), which causes a cooling of the heating surface when the temperature on the heating surface exceeds a preset value.

2. An apparatus according to claim 1, characterised in that a temperature sensor (50) is assigned to the heating surface, whose measured temperature value is given up to a control device (48), and the control device adjusts the supply of a coolant depending on the deviation of the measured temperature from a desired temperature value.

3. An apparatus according to claim 1, characterised in that the preheating station has a bar shaped block (28), with a flute (30) in which the endless tow is guided and wherein the bar shaped block (28) is assigned to a heating apparatus, characterised the cooling apparatus is assigned to the bar shaped block (28) also.

4. An apparatus according to claim 3, characterised in that the cooling apparatus directs a cooling fluid to the bar shaped block (28).

5. An apparatus according to claim 3, characterised in that at least one cooling channel (38, 40) is formed in the bar shaped block (28), which extends in the longitudinal direction of the bar shaped block (28) and is connected to the flute (30) in distances via bores (42, 44), and the cooling channel (38, 40) is connected with a source (46) for pressurised cooling fluid.

6. An apparatus according to claim 5, characterised in that two parallel cooling channels (38, 40) run near to the flute (30), which are connected to the flute (30) near to the facing edges of the flute via radial bores (42, 44).
